(19) United States
(12) Patent Application Publication
(10) Pub. No.: US 2019/0096240 A1
(43) Pub. Date: Mar. 28, 2019

(54) METHOD AND APPARATUS FOR OPTIMIZING TRAFFIC SCHEME FOR PASSING THROUGH CONGESTED ROADS

(71) Applicant: BOE TECHNOLOGY GROUP CO., LTD., Beijing (CN)

(72) Inventor: Xiao CHU, Beijing (CN)

(73) Assignee: BOE TECHNOLOGY GROUP CO., LTD., Beijing (CN)

(21) Appl. No.: 15/964,945

(22) Filed: Apr. 27, 2018

(30) Foreign Application Priority Data
Sep. 28, 2017 (CN) 201710899039.5

(51) Int. Cl. G08G 1/01; G01C 21/34; G01C 21/36

(52) U.S. Cl. CPC G08G 1/0145; G01C 21/3423; G01C 21/3691; G01C 21/3492; G01C 21/3415

(57) ABSTRACT

A method and apparatus for optimizing traffic scheme for passing through congested roads are disclosed. The method includes: obtaining passing time information for an i-th congested road, and processing the obtained passing time information for an i-th congested road to determine taking which kind of public transport tools to go to an underground railway station.

### CROSS-REFERENCE TO RELATED APPLICATION

This application claims priority to Chinese Patent Application No. 201710899039.5 filed on Sep. 28, 2017, which is incorporated herein by reference in its entirety.

### TECHNICAL FIELD

The present disclosure relates to the field of intelligent transportation technology, and in particular to a method and apparatus for optimizing traffic scheme for passing through congested roads.

### BACKGROUND

With improvement of people's living standards, many families already have their own cars to facilitate daily travel. However, this also results in problems such as urban traffic congestion and environmental pollution. As present, many cities are equipped with public transport tools such as buses, taxis and subways, so that people can take public transport tools as much as possible when travelling, thereby reducing traffic congestion and environmental pollution.

Although travelling by the public transport tools can reduce traffic congestion and environmental pollution in some extent, when a person is far away from a subway station, the person has to travel by a taxi or by bus. In such a case, traffic congestion will occur during peak hour traffic.

### SUMMARY

One embodiment of the present disclosure provides a method for optimizing traffic scheme for passing through congested roads, which includes:

step S100: obtaining passing time information for an i-th congested road, wherein the passing time information for the i-th congested road includes: a first travel time tᵢ₁ required for traveling by a first public transport tool from an i-th starting position to a starting end of the i-th congested road, a walking time t_{i′} required for walking from the starting end of the i-th congested road to a parking place of a second public transport tool closest to the starting end of the i-th congested road, a second travel time tᵢ₂ required for traveling by the second public transport tool from the i-th starting position to an underground railway station, where 1≤i≤n, and n represents a quantity of all congested roads in a guidance route between an initial position and the underground railway station;

step S300: determining whether tᵢ₁+t_{i′} is greater than tᵢ₂;

when tᵢ₁+t_{i′} >tᵢ₂, generating first traffic optimization information that includes traveling by the second public transport tool from the i-th starting position to the underground railway station; otherwise, performing step S400;

step S400: obtaining a third travel time tᵢ₃ required for traveling by the second public transport tool from the parking place of the second public transport tool closest to the starting end of the i-th congested road to the underground railway station; determining whether tᵢ₁+t_{i′}+tᵢ₃ is greater than tᵢ₂; when tᵢ₁+t_{i′}+tᵢ₃>tᵢ₂, generating the first traffic optimization information; otherwise, generating second traffic optimization information that includes traveling by the first public transport tool from the i-th starting position to the starting end of the i-th congested road, walking from the starting end of the i-th congested road to the parking place of the second public transport tool closest to the starting end of the i-th congested road, and traveling by the second public transport tool from the parking place of the second public transport tool closest to the starting end of the i-th congested road to the underground railway station.

Comparing with the related art, in the above method, the first travel time tᵢ₁ required for traveling by the first public transport tool from the i-th starting position to the starting end of the i-th congested road, the walking time t_{i′} required for walking from the starting end of the i-th congested road to the parking place of the second public transport tool closest to the starting end of the i-th congested road, and the second travel time tᵢ₂ required for traveling by the second public transport tool from the i-th starting position to the underground railway station are first obtained. Then, it is determined whether tᵢ₁+t_{i′} is greater than tᵢ₂. If tᵢ₁+t_{i′} is greater than tᵢ₂, it indicates that traveling by the second public transport tool from the initial position to the underground railway station can save time and thus the first traffic optimization information is generated based on this. If tᵢ₁+t_{i′} is not greater than tᵢ₂, it is needed to obtain the third travel time tᵢ₃ required for traveling by the second public transport tool from the parking place of the second public transport tool closest to the starting end of the i-th congested road to the underground railway station, and then determine whether tᵢ₁+t_{i′}+tᵢ₃ is greater than tᵢ₂. If tᵢ₁+t_{i′}+tᵢ₃ is greater than tᵢ₂, it is determined that the first traffic optimization scheme for congested roads can still save time. If tᵢ₁+t_{i′}+tᵢ₃ is greater than tᵢ₂, it is indicated that the first traffic optimization scheme for congested roads takes a long time and then a transfer mode is adopted, for example, traveling by the first public transport tool from the i-th starting position to the starting end of the i-th congested road, walking from the starting end of the i-th congested road to the parking place of the second public transport tool closest to the starting end of the i-th congested road, and traveling by the second public transport tool from the parking place of the second public transport tool closest to the starting end of the i-th congested road to the underground railway station. Therefore, on the basis of time factors, the above method can use the second public transport that can pass through congested road to pass through the congested roads when traffic congestion occurs, and thus it is able to reach the underground railway station at the shortest time without time delay.

Further, in the above method, each of the first traffic optimization scheme for congested roads and the second traffic optimization scheme for congested roads uses the second public transport tool to pass through the congested road to reach the underground railway station. The difference between the first traffic optimization scheme for congested roads and the second traffic optimization scheme for congested roads lies in that the first traffic optimization scheme for congested roads includes travelling by the second public transport tool from the i-th starting position to the underground railway station, while the second traffic optimization scheme for congested roads includes first travelling by the first public transport tool from the i-th starting position to the starting end of the i-th congested road, then walking to the second public transport tool and then travelling by the second public transport tool to the underground railway station. Therefore, in the above method, only one transfer is needed at most before reaching the underground railway station, thereby minimizing the number of unnecessary transfers and thus optimizing the travel scheme.

In addition, the above method is based on the time factors, and can avoid user's operation of selecting the best travel scheme, thereby greatly facilitating the user's design of the travel scheme.

One embodiment of the present disclosure further provides an apparatus for optimizing traffic scheme for passing through congested roads, which includes:

an obtaining circuit configured to obtain passing time information for an i-th congested road, wherein the passing time information for the i-th congested road includes: a first travel time tᵢ₁ required for traveling by a first public transport tool from an i-th starting position to a starting end of the i-th congested road, a walking time t_{i′} required for walking from the starting end of the i-th congested road to a parking place of a second public transport tool closest to the starting end of the i-th congested road, a second travel time tᵢ₂ required for traveling by the second public transport tool from the i-th starting position to an underground railway station, where 1≤i≤n, and n represents a quantity of all congested roads in a guidance route between an initial position and the underground railway station;

a first determining circuit configured to determine whether tᵢ₁+t_{i′} is greater than tᵢ₂;

an information generation circuit configured to, when tᵢ₁+t_{i′} >tᵢ₂, generate first traffic optimization information that includes traveling by the second public transport tool from the i-th starting position to the underground railway station;

a second determining circuit configured to determine whether tᵢ₁+t_{i′}+tᵢ₃ is greater than tᵢ₂;

wherein the obtaining circuit is further configured to, when tᵢ₁+t_{i′}≤tᵢ₂, obtain a third travel time tᵢ₃ required for traveling by the second public transport tool from the parking place of the second public transport tool closest to the starting end of the i-th congested road to the underground railway station;

wherein the information generation circuit is further configured to, when tᵢ₁+t_{i′}+tᵢ₃>tᵢ₂, generate the first traffic optimization information; when tᵢ₁+t_{i′}+tᵢ₃≤tᵢ₂, generate second traffic optimization information that includes traveling by the first public transport tool from the i-th starting position to the starting end of the i-th congested road, walking from the starting end of the i-th congested road to the parking place of the second public transport tool closest to the starting end of the i-th congested road, and traveling by the second public transport tool from the parking place of the second public transport tool closest to the starting end of the i-th congested road to the underground railway station.

### BRIEF DESCRIPTION OF THE DRAWINGS

The accompanying drawings, which are incorporated in and constitute a part of this specification, illustrate embodiments consistent with the present disclosure and, together with the description, serve to explain the principles of the present disclosure.

FIG. 1 is a flow chart of a method for optimizing traffic scheme for passing through congested roads according to an embodiment of the present disclosure;

FIG. 2 is an information interaction diagram of obtaining passing time information for an i-th congested road according to an embodiment of the present disclosure;

FIG. 3 is a schematic diagram showing a traffic condition between an initial position and an underground railway station;

FIG. 4 is a block diagram of an apparatus for optimizing traffic scheme for passing through congested roads according to an embodiment of the present disclosure;

FIG. 5 is a schematic diagram showing information interaction between apparatus for optimizing traffic scheme for passing through congested roads and a client according to an embodiment of the present disclosure;

FIG. 6 is a block diagram of a terminal device for optimizing traffic scheme for passing through congested roads according to an embodiment of the present disclosure; and

FIG. 7 is a flow chart of a method for optimizing traffic scheme for passing through congested roads according to an embodiment of the present disclosure.

### DETAILED DESCRIPTION

Detailed description of the exemplary embodiments will be made herein, with examples thereof to be shown in drawings. In the following descriptions, when the drawings are referred to, unless expressed otherwise, the same number in different drawings refers to the same or similar elements. The embodiments described in the exemplary embodiments as below do not represent all embodiments that are consistent with the present disclosure. On the contrary, they are only examples of the devices and the methods that are consistent with some of the aspects of the present disclosure as recited in the claims.

A method and apparatus for optimizing traffic scheme for passing through congested roads are provided according to embodiments of the present disclosure, and may be applied to a scene in which there are n congested roads in a guidance route for travelling by a public transport tool from an initial position to an underground railway station that is at a certain distance from the initial position, where n is an integer greater than or equal to 1. The public transport tool may be a taxi or a shared bike, etc. A route from the initial position to the underground railway station is defined as the guidance route. The guidance route may be a shortest-distance path or a long-distance path.

It should be noted that there are usually several options for the route from the initial position to the underground railway station, and a shortest route may be selected as the guidance route to save time.

The public transport tools may be divided into a first public transport tool and a second public transport tool according to whether they can pass through the congested road. A driving speed of the first public transport tool is greater than a driving speed of the second public transport tool. The first public transport tool slows down and even stops in the congested road, such as a taxi. The second public transport tool keeps running at a normal speed in the congested road, such as a shared bike.

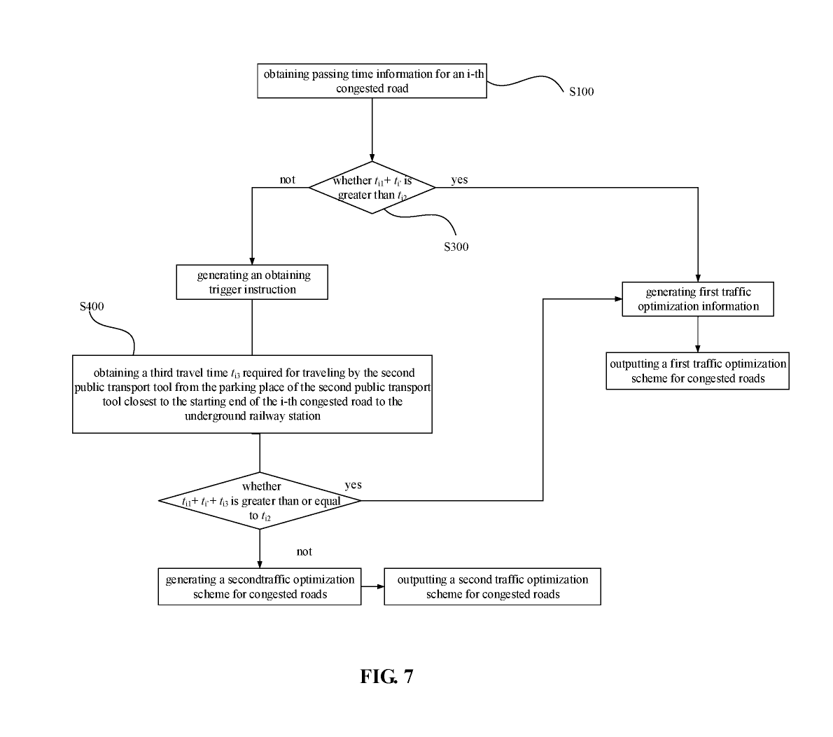

Referring to FIG. 7, one embodiment of the present disclosure provides a method for optimizing traffic scheme for passing through congested roads. Based on an electronic map client and a traffic tool distribution query client in the related art, the method obtains and processes relevant time data, to optimize traffic scheme for passing through congested roads encountered in a trip. As a result, it is able to reach an underground railway station (such as a subway station) without time delay, and thus travelling without delay can be realized. Specifically, the method includes the following steps S100, S300 and S400.

The step S100 is to obtain passing time information for an i-th congested road. The passing time information for the i-th congested road includes: a first travel time tᵢ₁ required for traveling by a first public transport tool from an i-th starting position to a starting end of the i-th congested road, a walking time t_{i′} required for walking from the starting end of the i-th congested road to a parking place of a second public transport tool closest to the starting end of the i-th congested road, a second travel time tᵢ₂ required for traveling by the second public transport tool from the i-th starting position to an underground railway station, where 1≤i≤n, and n represents a quantity of all congested roads in a guidance route between an initial position and the underground railway station.

The step S300 is to determine whether tᵢ₁+t_{i′} is greater than tᵢ₂; when tᵢ₁+t_{i′} >tᵢ₂, generate first traffic optimization information that includes traveling by the second public transport tool from the i-th starting position to the underground railway station; otherwise, perform the step S400.

The step S400 is to obtain a third travel time tᵢ₃ required for traveling by the second public transport tool from the parking place of the second public transport tool closest to the starting end of the i-th congested road to the underground railway station; determine whether tᵢ₁+t_{i′}+tᵢ₃ is greater than tᵢ₂; when tᵢ₁+t_{i′}+tᵢ₃>tᵢ₂, generate the first traffic optimization information; otherwise, generate second traffic optimization information. The second traffic optimization information includes traveling by the first public transport tool from the i-th starting position to the starting end of the i-th congested road, walking from the starting end of the i-th congested road to the parking place of the second public transport tool closest to the starting end of the i-th congested road, and traveling by the second public transport tool from the parking place of the second public transport tool closest to the starting end of the i-th congested road to the underground railway station.

In the above method, the first travel time tᵢ₁ required for traveling by the first public transport tool from the i-th starting position to the starting end of the i-th congested road, the walking time t_{i′} required for walking from the starting end of the i-th congested road to the parking place of the second public transport tool closest to the starting end of the i-th congested road, and the second travel time tᵢ₂ required for traveling by the second public transport tool from the i-th starting position to the underground railway station are first obtained. Then, it is determined whether tᵢ₁+t_{i′} is greater than tᵢ₂. If tᵢ₁+t_{i′} is greater than tᵢ₂, it indicates that traveling by the second public transport tool from the initial position to the underground railway station can save time and thus the first traffic optimization information is generated based on this. If tᵢ₁+t_{i′} is not greater than tᵢ₂, it is needed to obtain the third travel time tᵢ₃ required for traveling by the second public transport tool from the parking place of the second public transport tool closest to the starting end of the i-th congested road to the underground railway station, and then determine whether tᵢ₁+t_{i′}+tᵢ₃ is greater than tᵢ₂. If tᵢ₁+t_{i′}+tᵢ₃ is greater than tᵢ₂, it is determined that the first traffic optimization scheme for congested roads can still save time. If tᵢ₁+t_{i′}+tᵢ₃ is greater than tᵢ₂, it is indicated that the first traffic optimization scheme for congested roads takes a long time and then a transfer mode is adopted, for example, traveling by the first public transport tool from the i-th starting position to the starting end of the i-th congested road, walking from the starting end of the i-th congested road to the parking place of the second public transport tool closest to the starting end of the i-th congested road, and traveling by the second public transport tool from the parking place of the second public transport tool closest to the starting end of the i-th congested road to the underground railway station. Therefore, on the basis of time factors, the above method can use the second public transport that can pass through congested road to pass through the congested roads when traffic congestion occurs, and thus it is able to reach the underground railway station at the shortest time without time delay.

Further, in the above method, each of the first traffic optimization scheme for congested roads and the second traffic optimization scheme for congested roads uses the second public transport tool to pass through the congested road to reach the underground railway station. The difference between the first traffic optimization scheme for congested roads and the second traffic optimization scheme for congested roads lies in that the first traffic optimization scheme for congested roads includes travelling by the second public transport tool from the i-th starting position to the underground railway station, while the second traffic optimization scheme for congested roads includes first travelling by the first public transport tool from the i-th starting position to the starting end of the i-th congested road, then walking to the second public transport tool and then travelling by the second public transport tool to the underground railway station. Therefore, in the above method, only one transfer is needed at most before reaching the underground railway station, thereby minimizing the number of unnecessary transfers and thus optimizing the travel scheme.

In addition, the above method is based on the time factors, and can avoid user's operation of selecting the best travel scheme, thereby greatly facilitating the user's design of the travel scheme.

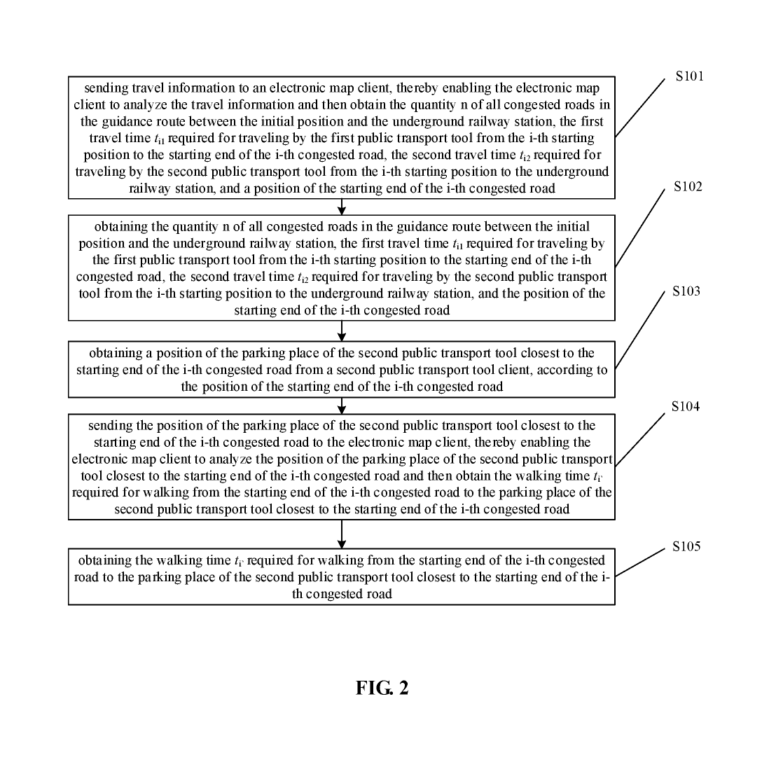

Specifically, as shown in FIG. 2, the obtaining passing time information for an i-th congested road in the above embodiment includes the following steps S101, S102, S103, S104 and S105.

The step S101 is to send travel information to an electronic map client, thereby enabling the electronic map client to analyze the travel information and then obtain the quantity n of all congested roads in the guidance route between the initial position and the underground railway station, the first travel time tᵢ₁ required for traveling by the first public transport tool from the i-th starting position to the starting end of the i-th congested road, the second travel time tᵢ₂ required for traveling by the second public transport tool from the i-th starting position to the underground railway station, and a position of the starting end of the i-th congested road.

The step S102 is to obtain the quantity n of all congested roads in the guidance route between the initial position and the underground railway station, the first travel time tᵢ₁ required for traveling by the first public transport tool from the i-th starting position to the starting end of the i-th congested road, the second travel time tᵢ₂ required for traveling by the second public transport tool from the i-th starting position to the underground railway station, and the position of the starting end of the i-th congested road.

The step S103 is to obtain a position of the parking place of the second public transport tool closest to the starting end of the i-th congested road from a second public transport tool client, according to the position of the starting end of the i-th congested road.

The step S104 is to input the position of the parking place of the second public transport tool closest to the starting end of the i-th congested road to the electronic map client, thereby enabling the electronic map client to analyze the position of the parking place of the second public transport tool closest to the starting end of the i-th congested road and then obtain the walking time t_{i′} required for walking from the starting end of the i-th congested road to the parking place of the second public transport tool closest to the starting end of the i-th congested road.

The step S105 is to obtain the walking time t_{i′} required for walking from the starting end of the i-th congested road to the parking place of the second public transport tool closest to the starting end of the i-th congested road.

As can be seen from the above description, in one embodiment, the time data may be obtained based on the electronic map client and the transport tool client in the related art. The transport tool client may be a shared-bike client and is easily implemented by hardware and software, without developing a new transport tool client, thereby facilitating implementation of the method.

Of course, the third travel time tᵢ₃ required for traveling by the second public transport tool from the parking place of the second public transport tool closest to the starting end of the i-th congested road to the underground railway station may be obtained from the electronic map client.

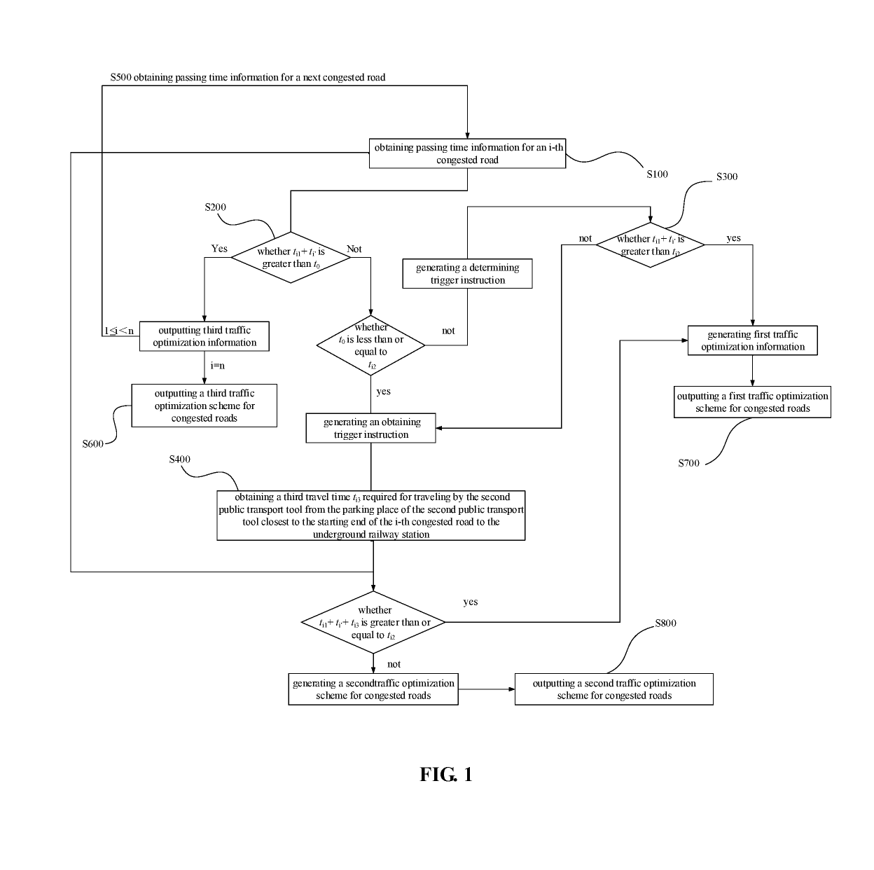

Considering that the public transport tool that can pass through the congested roads is usually a shared bike and the shared bike has a reservation time limit. Based on this, when the second public transport tool has a reservation time threshold t₀, as shown in FIG. 1, before the step S100 and the step S300, the method further includes a step S200.

The step S200 is to determine whether tᵢ₁+t_{i′} is greater than t₀; when tᵢ₁+t_{i′} >t₀, generate third traffic optimization information that includes traveling by the first public transport tool from the i-th starting position to a starting end of an (i+1)-th congested road; when tᵢ₁+t_{i′}≤t₀, perform the step S400.

That is to say, when the second public transport tool has the reservation time threshold t₀, the reservation time threshold t₀ of the second public transport tool is introduced in the method, and is used as a reference data to analyze whether there is a problem with reservation overdue when using the second public transport tool, thereby avoiding the problem of travel delays which may be caused because the reservation time threshold t₀ of the second public transport tool is not taken into account, and the second public transport tool could not be used due to reservation overdue when reaching the parking place of the second public transport tool. Therefore, the method introduces the reservation time threshold t₀ of the second public transport tool as a reference data, thereby ensuring the results obtained from analyses more accurate and then reducing unnecessary delays of the travel time.

It should be noted that, in the above embodiment, when tᵢ₁+t_{i′}≤t₀ or tᵢ₁+t_{i′}≤tᵢ₂, it is needed to obtain the third travel time tᵢ₃ required for traveling by the second public transport tool from the parking place of the second public transport tool closest to the starting end of the i-th congested road to the underground railway station; in order to simplify the analyzing process, as shown in FIG. 1, the above method may further include: when tᵢ₁+t_{i′}≤t₀, before performing the step S400, the method further includes: determining whether t₀ is less than or equal to tᵢ₂; when t₀≤tᵢ₂, performing the step S400; otherwise, performing the step S300.

As can be seen from the above description about the process of obtaining the third travel time tᵢ₃ in a variety of situations, by determining whether t₀ is less than or equal to tᵢ₂ when tᵢ₁+t_{i′}≤t₀, a process of comparing tᵢ₁+t_{i′} with the tᵢ₂ can be omitted when t₀>tᵢ₂, thereby directly starting the process of obtaining the third travel time tᵢ₃ and then simplifying steps.

In addition, a quantity of all congested roads in the guidance route between the initial position and the underground railway station may be an integer greater than or equal to 1.

When a quantity n of congested roads in the guidance route is equal to 1, the i-th starting position is the initial position. At this point, the third traffic optimization information includes traveling by the first public transport tool from the initial position to the underground railway station.

When a quantity n of congested roads in the guidance route is greater than or equal to 2, when i=1, the i-th starting position is the initial position; and when i≥2, the i-th starting position is the starting end of the i-th congested road.

Further, as shown in FIG. 1, the method further includes: when tᵢ₁+t_{i′} >t₀, performing a step S500 when 1≤i<n, and performing a step S600 when i=n.

The step S500 includes: when 1≤i<n, returning back to the step S100 to obtain passing time information for a next congested road.

The step S600 includes: outputting a third traffic optimization scheme for congested roads. The third traffic optimization scheme for congested roads includes traveling by the first public transport tool from the initial position to the underground railway station.

When tᵢ₁+t_{i′} >tᵢ₂ and i=1, the step S300 further includes performing a step S700.

When tᵢ₁+t_{i′}+tᵢ₃>tᵢ₂ and i=1, the step S400 further includes performing the step S700.

The step S700 includes: outputting a first traffic optimization scheme for congested roads. The first traffic optimization scheme for congested roads includes traveling by the second public transport tool from the initial position to the underground railway station.

When tᵢ₁+t_{i′}+tᵢ₃≤tᵢ₂, the step S400 further includes performing a step S800;

The step S800 includes: outputting a second traffic optimization scheme for congested roads. The second traffic optimization scheme for congested roads includes: traveling by the first public transport tool from the initial position to the starting end of the i-th congested road, walking from the starting end of the i-th congested road to the parking place of the second public transport tool closest to the starting end of the i-th congested road, and traveling by the second public transport tool from the parking place of the second public transport tool closest to the starting end of the i-th congested road to the underground railway station.

It should be noted that, the first public transport tool cannot pass through the congested roads. The public transport tool is generally a taxi or a bus. Since the bus cannot be called at any time, the bus can only reach fixed bus stations at regular intervals, and thus has more restrictions on time and position. Therefore, the second public transport tool may be a taxi that can be called by a taxi client such as a Didi taxi client. At this point, when i=1, the first travel time tᵢ₁ includes a walking time tᵢ₁₁ required for walking from the i-th starting position to a parking place of the first public transport tool closest to the i-th starting position, a waiting time tᵢ₁₂ required for waiting for the first public transport tool at the parking place of the first public transport tool closest to the i-th starting position, and a driving time tᵢ₁₃ required for travelling by the first public transport tool from the parking place of the first public transport tool closest to the i-th starting position to the starting end of the i-th congested road. The second travel time tᵢ₂ includes a walking time tᵢ₂₁ required for walking from the i-th starting position to the parking place of the second public transport tool closest to the i-th starting position, and a driving time tᵢ₂₂ required for travelling by the second public transport tool from the parking place of the second public transport tool closest to the i-th starting position to the underground railway station. When i=1, the i-th starting position refers to the initial position. When i≥2, since the i-th starting position refers to the starting end of the i-th congested road, tᵢ₁=0, tᵢ₂=t_{i′}+tᵢ₃.

FIG. 3 is a schematic diagram showing a traffic condition between an initial position A and an underground railway station. The underground railway station is a subway station, and there are two subway stations including a first subway station C1 and a second subway station C2.

The first public transport tool may be a taxi, and the second public transport tool may be a shared bike having a reservation time threshold t₀. It is assumed that a first guidance route a is adopted to travel from the initial position A to the first subway station C1, and there is one congested road that is defined as a first congested road in the first guidance route a. Specifically, in order to optimize the first guidance route, the method of the above embodiment may include the flowing steps S100A, S200A, S400A, S600A, S700A and S800A.

The step S100A is to obtain a first travel time tᵢ₁ required for traveling by the taxi from the initial position A to a starting end B11 of the first congested road, a walking time t_{i′} required for walking from the starting end B11 of the first congested road to a parking place Kb1 of shared bikes closest to the starting end B11 of the first congested road, a second travel time t₁₂ required for traveling by the shared bike from the initial position A to the first subway station C1.

The first travel time tᵢ₁ includes a walking time t₁₁₁ required for walking from the initial position A to a parking place R of taxis closest to the initial position, a waiting time t₁₁₂ required for waiting for the taxi at the parking place R of taxis closest to the initial position, and a driving time t₁₁₃ required for travelling by the taxi from the parking place R of taxis closest to the initial position to the starting end B11 of the first congested road. The second travel time t₁₂ includes a walking time t₁₂₁ required for walking from the initial position A to the parking place Ka of shared bikes closest to the initial position, and a driving time t₁₂₂ required for travelling by the shared bike from the parking place Ka of shared bikes closest to the initial position to the first subway station C1.

The step S200A is to determine whether t₁₁+t_{i′} is greater than t₀; when t₁₁+t_{i′} is greater than t₀, generate third traffic optimization information that includes traveling by the taxi from the initial position to the first subway station C1, and perform the step S600A; when t₁₁+t_{i′} is not greater than t₀, determine whether t₀ is less than or equal to tᵢ₂, and perform the step S400A when t₀ is less than or equal to t₁₂, otherwise, perform the step S300A.

The step S300A is to determine whether t₁₁+t_{i′} is greater than t₁₂; when t₁₁+t_{i′} is greater than t₁₂, generate first traffic optimization information and perform the step S700A; and when t₁₁+t_{i′} is not greater than t₁₂, perform the step S400A.

The first traffic optimization information includes traveling by the shared bike from the initial position A to the first subway station C1. The traveling by the shared bike from the initial position A to the first subway station C1 includes traveling from the initial position A to the parking place Ka of shared bikes closest to the initial position, and riding the shared bike from the parking place Ka of shared bikes closest to the initial position to the first subway station C1.

The step S400A is to obtain a third travel time t₁₃ required for traveling by the shared bike from the parking place Kb1 of the shared bike closest to the starting end of the first congested road to the first subway station C1; determine whether t₁₁+t_{1′}+t₁₃ is greater than t₁₂; when t₁₁+t_{i′}+t₁₃ is greater than t₁₂, generate the first traffic optimization information and performing the step S700A; when t₁₁+t_{i′}+t₁₃ is not greater than t₁₂, generate second traffic optimization information and perform the step S800A.

The second traffic optimization information includes traveling by the taxi from the initial position to the starting end of the first congested road, walking from the starting end B11 of the first congested road to the parking place Kb1 of shared bikes closest to the starting end of the first congested road, and traveling by the shared bike from the parking place Kb1 of shared bikes closest to the starting end of the first congested road to the first subway station C1. The traveling by the taxi from the initial position to the starting end of the first congested road includes travelling from the initial position to the parking place R of taxis closest to the initial position, waiting for the taxi at the parking place R of taxis closest to the initial position, and travelling from the parking place R of taxis closest to the initial position to the starting end B11 of the first congested road.

The step S600A is to output a third traffic optimization scheme for congested roads. The third traffic optimization scheme for congested roads includes traveling by the taxi from the initial position A to the first subway station C1;

The step S700A is to output a first traffic optimization scheme for congested roads. The first traffic optimization scheme for congested roads includes traveling by the shared bike from the initial position A to the first subway station C1.

The step S800A is to output a second traffic optimization scheme for congested roads. The second traffic optimization scheme for congested roads includes: traveling by the taxi from the initial position to the starting end B11 of the first congested road, walking from the starting end of the first congested road to the parking place Kb1 of shared bikes closest to the starting end of the first congested road, and traveling by the shared bike from the parking place Kb1 of shared bikes closest to the starting end of the first congested road to the first subway station C1.

Further, when an end position of a trip is another underground railway station, then it is able to travel according to the above method. As shown in FIG. 3, after a traffic optimization scheme is generated for corresponding congested roads according to the above method, on the basis of this, it is able to travel from the first subway station C1 to the end position Z.

It is assumed that a second guidance route b is adopted to travel from the initial position A to the second subway station C2, and there are two congested roads that are defined as a first congested road and a second congested road in the second guidance route. Specifically, in order to optimize the second guidance route, the method of the above embodiment may include the flowing steps S100B1 to S800B1.

The step S100B1 is to obtain a first travel time t₁₁ required for traveling by the taxi from the initial position A to a starting end B11 of the first congested road, a walking time t_{i′} required for walking from the starting end B11 of the first congested road to a parking place Kb of shared bikes closest to the starting end B11 of the first congested road, a second travel time t₁₂ required for traveling by the shared bike from the initial position A to the second subway station C2.

The first travel time tᵢ₁ includes a walking time t₁₁₁ required for walking from the initial position A to a parking place R of taxis closest to the initial position, a waiting time t₁₁₂ required for waiting for the taxi at the parking place R of taxis closest to the initial position, and a driving time t₁₁₃ required for travelling by the taxi from the parking place R of taxis closest to the initial position to the starting end B11 of the first congested road. The second travel time t₁₂ includes a walking time t₁₂₁ required for walking from the initial position A to the parking place Ka of shared bikes closest to the initial position, and a driving time t₁₂₂ required for travelling by the shared bike from the parking place Ka of shared bikes closest to the initial position to the second subway station C2.

The step S200B1 is to determine whether t₁₁+t_{i′} is greater than t₀; when t₁₁+t_{i′} is greater than t₀, generate third traffic optimization information that includes traveling by the taxi from the initial position to a starting end of the second congested road, and perform the step S500B1; when t₁₁+t_{i′} is not greater than t₀, determine whether t₀ is less than or equal to t₁₂; when t₀ is less than or equal to t₁₂, perform the step S400B1; otherwise, perform the step S300B1.

The step S300B1 is to determine whether t₁₁+t_{i′} is greater than t₁₂; when t₁₁+t_{i′} is greater than t₁₂, generate first traffic optimization information and perform the step S700B1; when t₁₁+t_{i′} is not greater than t₁₂, perform the step S400B1.

The first traffic optimization information includes traveling by the shared bike from the initial position A to the second subway station C2. The traveling by the shared bike from the initial position A to the second subway station C2 further includes traveling from the initial position A to the parking place Ka of shared bikes closest to the initial position, and riding the shared bike from the parking place Ka of shared bikes closest to the initial position to the second subway station C2.

The step S400B1 is to obtain a third travel time t₂₃ required for traveling by the shared bike from the parking place Kb1 of the shared bike closest to the starting end of the first congested road to the second subway station C2; determine whether t₂₁+t₂′+tᵢ₂₃ is greater than t₂₂; when t₂₁+t_{2′}+tᵢ₂₃ is greater than t₂₂, generate the first traffic optimization information, and perform the step S700B1; when t₂₁+t_{2′}+tᵢ₂₃ is not greater than t₂₂, generate second traffic optimization information, and perform the step S800B1.

The second traffic optimization information includes traveling by the taxi from the initial position to the starting end of the first congested road, walking from the starting end B11 of the first congested road to the parking place Kb1 of shared bikes closest to the starting end of the first congested road, and traveling by the shared bike from the parking place Kb of shared bikes closest to the starting end of the first congested road to the second subway station C2. The traveling by the taxi from the initial position to the starting end of the first congested road includes travelling from the initial position to the parking place R of taxis closest to the initial position, waiting for the taxi at the parking place R of taxis closest to the initial position, and travelling from the parking place R of taxis closest to the initial position to the starting end B11 of the first congested road.

The step S500B1 is to obtain passing time information for the second congested road in a manner which includes the following steps S100B2 to S400B2.

The step S100B2 is to obtain a first travel time t₂₁ required for traveling by the taxi from the starting end B21 of the second congested road to the starting end B21 of the second congested road, apparently, t₂₁=0, a walking time t_{2′} required for walking from the starting end B21 of the second congested road to a parking place Kb2 of shared bikes closest to the starting end B21 of the second congested road, and a second travel time t₂₂ required for traveling by the shared bike from the starting end B21 of the second congested road to the second subway station C2; where t₂₂=t_{2′}+t₂₃.

The step S200B2 is to determine whether t_{2′} is greater than t₀; when t_{2′} is greater than t₀, generate third traffic optimization information that includes traveling by the taxi from the starting end B21 of the second congested road to the second subway station C2 and perform the step S600B1; when t_{2′} is not greater than t₀, determine whether t₀ is less than or equal to t₂₂; when t₀ is less than or equal to t₂₂, perform the step S400B2; otherwise, performing step S300B2;

The step S300B2 is to determine whether t₂₁+t_{2′} is greater than t₂₂; since t₂₁=0 and t₂₂=t_{2′}+t₂₃ as well as t₂₃>0, t₂₁+t_{2′} is less than or equal to t_{22′}, perform the step S400B2.

The step S400B2 is to obtain a third travel time t₂₃ required for traveling by the shared bike from the parking place Kb2 of the shared bike closest to the starting end of the second congested road to the second subway station C2; determine whether t₂₁+t₂′+t₂₃ is greater than t₂₂, i.e., whether t_{2′}+t₂₃ is greater than t₂₂; since t₂₂=t_{2′}+t₂₃, generate second traffic optimization information, and perform the step S800B1.

The second traffic optimization information includes walking from the starting end B21 of the second congested road to the parking place Kb2 of shared bikes closest to the starting end of the second congested road, and traveling by the shared bike from the parking place Kb2 of shared bikes closest to the starting end of the second congested road to the second subway station C2.

The step S600B1 is to output a third traffic optimization scheme for congested roads. The third traffic optimization scheme for congested roads includes traveling by the taxi from the initial position A to the second subway station C2. The traveling by the taxi from the initial position A to the second subway station C2 includes travelling from the initial position A to the parking place R of taxis closest to the initial position A, waiting for the taxi at the parking place R of taxis closest to the initial position, and travelling from the parking place R of taxis closest to the initial position to the second subway station C2.

The step S700B1 is to output a first traffic optimization scheme for congested roads. The first traffic optimization scheme for congested roads includes traveling by the shared bike from the initial position A to the second subway station C2. The traveling by the shared bike from the initial position A to the second subway station C2 includes: travelling from the initial position A to the parking place Ka of shared bikes closest to the initial position, and riding the shared bike from the parking place Ka of shared bikes closest to the initial position to the second subway station C2.

The step S800B1 is to output a second traffic optimization scheme for congested roads. The second traffic optimization scheme for congested roads includes: traveling by the taxi from the initial position to the starting end B21 of the second congested road, walking from the starting end of the second congested road to the parking place Kb2 of shared bikes closest to the starting end of the second congested road, and travelling by the shared bike from the parking place Kb2 of shared bikes closest to the starting end of the second congested road to the second subway station C2. The traveling by the taxi from the initial position to the starting end B21 of the second congested road includes: travelling from the initial position A to the parking place R of taxis closest to the initial position, waiting for the taxi at the parking place R of taxis closest to the initial position, and travelling from the parking place R of taxis closest to the initial position to the starting end of the second congested road.

As can be seen from the above method for optimizing traffic scheme for passing through congested roads in the above two guidance routes, the method uses the shared bike to pass through the congested roads to improve traffic efficiency. However, when there is a long distance between the initial position and the underground railway station, riding the shared bike may affect travel speed. Therefore, the method in one embodiment is suitable for scenes in which riding the shared bike can quickly get the subway station.

Further, when an end position of a trip is another underground railway station, then it is able to travel according to the above method. As shown in FIG. 3, after a traffic optimization scheme is generated for corresponding congested roads according to the above method, on the basis of this, it is able to travel from the second subway station C2 to the end position Z.

Referring to FIG. 1, one embodiment of the present disclosure provides an apparatus for optimizing traffic scheme for passing through congested roads. Based on an electronic map client and a traffic tool distribution query client in the related art, the apparatus obtains and processes relevant time data, to optimize traffic scheme for passing through congested roads encountered in a trip. As a result, it is able to reach an underground railway station (such as a subway station) without time delay, and thus travelling without delay can be realized. Specifically, the apparatus includes: an obtaining circuit 1, a first determining circuit 2, an information generation circuit 3 and a second determining circuit 4.

The obtaining circuit 1 is configured to obtain passing time information for an i-th congested road. The passing time information for the i-th congested road includes: a first travel time tᵢ₁ required for traveling by a first public transport tool from an i-th starting position to a starting end of the i-th congested road, a walking time t_{i′} required for walking from the starting end of the i-th congested road to a parking place of a second public transport tool closest to the starting end of the i-th congested road, and a second travel time tᵢ₂ required for traveling by the second public transport tool from the i-th starting position to an underground railway station, where 1≤i≤n.

The first determining circuit 2 is configured to determine whether tᵢ₁+t_{i′} is greater than tᵢ₂.

The information generation circuit 3 is configured to, when tᵢ₁+t_{i′} >tᵢ₂, generate first traffic optimization information that includes traveling by the second public transport tool from the i-th starting position to the underground railway station. The obtaining circuit 1 is further configured to, when tᵢ₁+t_{i′}≤tᵢ₂, obtain a third travel time tᵢ₃ required for traveling by the second public transport tool from the parking place of the second public transport tool closest to the starting end of the i-th congested road to the underground railway station.

The second determining circuit 4 is configured to determine whether tᵢ₁+t_{i′}+tᵢ₃ is greater than tᵢ₂. The information generation circuit 3 is further configured to, when tᵢ₁+t_{i′}+tᵢ₃>tᵢ₂, generate the first traffic optimization information; when tᵢ₁+t_{i′}+tᵢ₃≤tᵢ₂, generate second traffic optimization information. The second traffic optimization information includes traveling by the first public transport tool from the i-th starting position to the starting end of the i-th congested road, walking from the starting end of the i-th congested road to the parking place of the second public transport tool closest to the starting end of the i-th congested road, and traveling by the second public transport tool from the parking place of the second public transport tool closest to the starting end of the i-th congested road to the underground railway station.

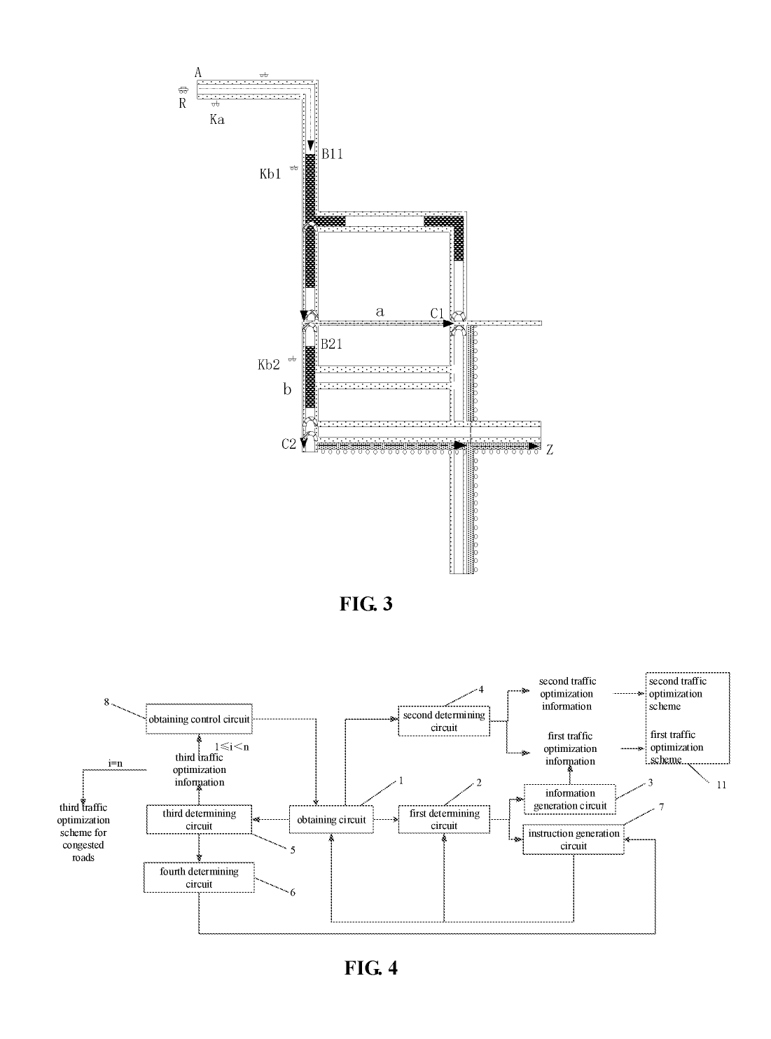

An implementation method of the apparatus will be described hereinafter in conjunction with FIG. 1, FIG. 4 and FIG. 7.

First, the obtaining circuit 1 obtains passing time information for an i-th congested road. The passing time information for the i-th congested road includes: a first travel time tᵢ₁ required for traveling by a first public transport tool from an i-th starting position to a starting end of the i-th congested road, a walking time t_{i′} required for walking from the starting end of the i-th congested road to a parking place of a second public transport tool closest to the starting end of the i-th congested road, and a second travel time tᵢ₂ required for traveling by the second public transport tool from the i-th starting position to an underground railway station, where 1≤i≤n, and n represents a quantity of all congested roads in a guidance route between an initial position and the underground railway station.

Second, the first determining circuit 2 determines whether tᵢ₁+t_{i′} is greater than tᵢ₂.

When tᵢ₁+t_{i′} >tᵢ₂, the information generation circuit 3 generates first traffic optimization information that includes traveling by the second public transport tool from the i-th starting position to the underground railway station. Otherwise, the obtaining circuit 1 obtains a third travel time tᵢ₃ required for traveling by the second public transport tool from the parking place of the second public transport tool closest to the starting end of the i-th congested road to the underground railway station.

Third, the second determining circuit 4 determines whether tᵢ₁+t_{i′}+tᵢ₃ is greater than tᵢ₂.

When tᵢ₁+t_{i′}+tᵢ₃>tᵢ₂, the information generation circuit 3 generates the first traffic optimization information. Otherwise, the information generation circuit 3 generates second traffic optimization information. The second traffic optimization information includes traveling by the first public transport tool from the i-th starting position to the starting end of the i-th congested road, walking from the starting end of the i-th congested road to the parking place of the second public transport tool closest to the starting end of the i-th congested road, and traveling by the second public transport tool from the parking place of the second public transport tool closest to the starting end of the i-th congested road to the underground railway station.

Comparing with the related art, the beneficial effects of the apparatus are the same or similar to those of the above method, and will not be repeated here.

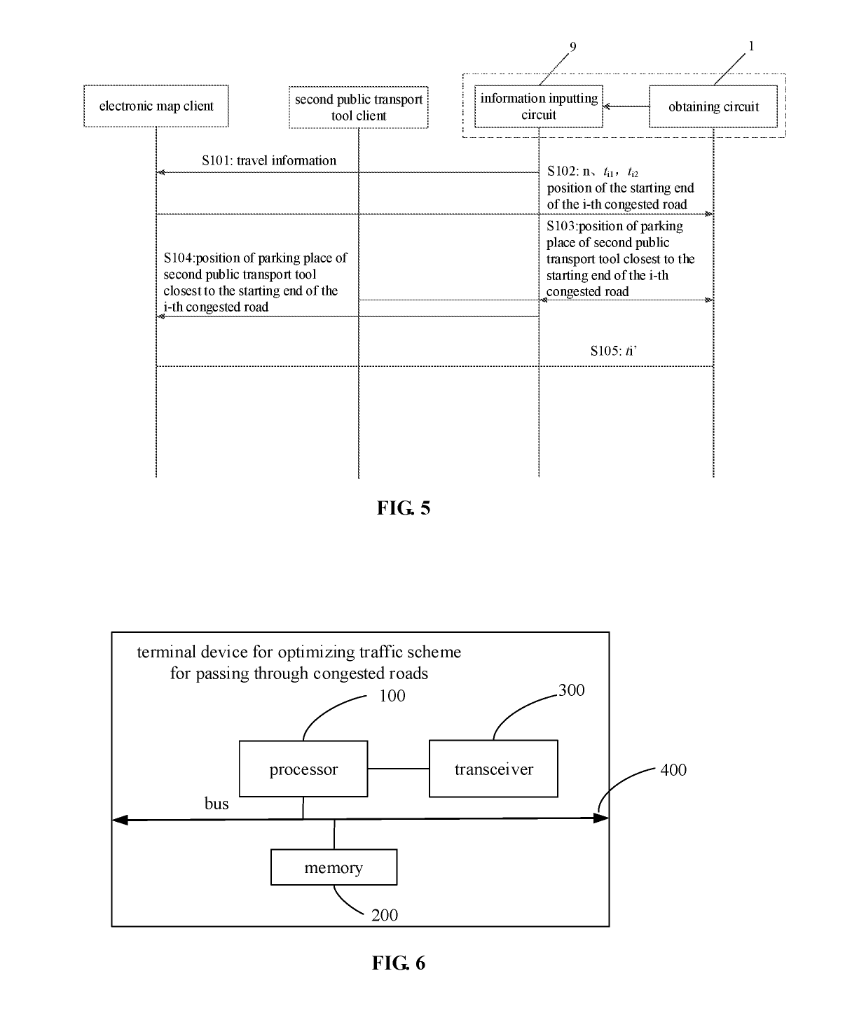

Optionally, as shown in FIG. 5, the above apparatus further includes an information inputting circuit 9. The information inputting circuit 9 is in communication with the electronic map client, the obtaining circuit 1 and the second traffic tool client. The information inputting circuit is configured to send travel information to the electronic map client. The travel information includes an initial position and an underground railway station.

The electronic map client analyzes the travel information and then obtains the quantity n of all congested roads in the guidance route between the initial position and the underground railway station, the first travel time tᵢ₁ required for traveling by the first public transport tool from the i-th starting position to the starting end of the i-th congested road, the second travel time tᵢ₂ required for traveling by the second public transport tool from the i-th starting position to the underground railway station, and a position of the starting end of the i-th congested road. The electronic map client sends the above information to the obtaining circuit 1.

The obtaining circuit 1 is in communication with the second traffic tool client, thereby enabling the obtaining circuit 1 to obtain the quantity n of all congested roads in the guidance route between the initial position and the underground railway station, the first travel time tᵢ₁ required for traveling by the first public transport tool from the i-th starting position to the starting end of the i-th congested road, the second travel time tᵢ₂ required for traveling by the second public transport tool from the i-th starting position to the underground railway station, and the position of the starting end of the i-th congested road.

The information inputting circuit is further configured to send the position of the parking place of the second public transport tool closest to the starting end of the i-th congested road to the electronic map client, thereby enabling the electronic map client to analyze the position of the parking place of the second public transport tool closest to the starting end of the i-th congested road and then obtain the walking time t_{i′} required for walking from the starting end of the i-th congested road to the parking place of the second public transport tool closest to the starting end of the i-th congested road, and enabling the obtaining circuit 12 to obtain the walking time.

Specifically, referring to FIG. 2 to FIG. 5, in one embodiment, the process that the obtaining circuit 1 obtains the above data includes the following steps S101 to S105.

At the step S101, the information inputting circuit 9 sends travel information to the electronic map client, thereby enabling the electronic map client to analyze the travel information and then obtain the quantity n of all congested roads in the guidance route between the initial position and the underground railway station, the first travel time tᵢ₁ required for traveling by the first public transport tool from the i-th starting position to the starting end of the i-th congested road, the second travel time tᵢ₂ required for traveling by the second public transport tool from the i-th starting position to the underground railway station, and a position of the starting end of the i-th congested road. The travel information includes the initial position and the underground railway station.

At step S102, the obtaining circuit 1 obtains the quantity n of all congested roads in the guidance route between the initial position and the underground railway station, the first travel time tᵢ₁ required for traveling by the first public transport tool from the i-th starting position to the starting end of the i-th congested road, the second travel time tᵢ₂ required for traveling by the second public transport tool from the i-th starting position to the underground railway station, and the position of the starting end of the i-th congested road.

At step S103, the obtaining circuit 1 obtains a position of the parking place of the second public transport tool closest to the starting end of the i-th congested road from the second public transport tool client, according to the position of the starting end of the i-th congested road; and sends the position of the parking place of the second public transport tool closest to the starting end of the i-th congested road to the information inputting circuit 9.

At step S104, the information inputting circuit 9 inputs the position of the parking place of the second public transport tool closest to the starting end of the i-th congested road to the electronic map client, thereby enabling the electronic map client to analyze the position of the parking place of the second public transport tool closest to the starting end of the i-th congested road and then obtain the walking time t_{i′} required for walking from the starting end of the i-th congested road to the parking place of the second public transport tool closest to the starting end of the i-th congested road.

At step S105, the obtaining circuit 1 obtains the walking time t_{i′} required for walking from the starting end of the i-th congested road to the parking place of the second public transport tool closest to the starting end of the i-th congested road.

As can be seen from the above description, in one embodiment, the time data may be obtained based on the electronic map client and the transport tool client in the related art. The transport tool client may be a shared-bike client and is easily implemented by hardware and software, without developing a new transport tool client, thereby facilitating implementation of the apparatus. Of course, the third travel time tᵢ₃ required for traveling by the second public transport tool from the parking place of the second public transport tool closest to the starting end of the i-th congested road to the underground railway station may be obtained from the electronic map client.

Considering that the public transport tool that can pass through the congested roads is usually a shared bike and the shared bike has a reservation time limit. Based on this, when the second public transport tool has a reservation time threshold t₀, as shown in FIG. 1 and FIG. 4, the apparatus further includes: a third determining circuit 5 configured to determine whether tᵢ₁+t_{i′} is greater than t₀.

The information generation circuit 3 is further configured to, when tᵢ₁+t_{i′} >t₀, generating third traffic optimization information that includes traveling by the first public transport tool from the i-th starting position to a starting end of an (i+1)-th congested road.

The obtaining circuit 1 is further configured to, when tᵢ₁+t_{i′} ≤t₀, obtain the third travel time tᵢ₃ required for traveling by the second public transport tool from the parking place of the second public transport tool closest to the starting end of the i-th congested road to the underground railway station.

An implementation process of the apparatus will be described hereinafter in conjunction with FIG. 1 and FIG. 3.

The third determining circuit 5 determines whether tᵢ₁+t_{i′} is greater than t₀.

When tᵢ₁+t_{i′}>t₀, the information generation circuit 3 generates third traffic optimization information that includes traveling by the first public transport tool from the i-th starting position to a starting end of an (i+1)-th congested road. The connection relationship between the third determining circuit 5 and the information generation circuit 3 is omitted.

When tᵢ₁+t_{i′}≤t₀, the obtaining circuit 1 obtains the third travel time tᵢ₃ required for traveling by the second public transport tool from the parking place of the second public transport tool closest to the starting end of the i-th congested road to the underground railway station.

That is to say, when the second public transport tool has the reservation time threshold t₀, the reservation time threshold t₀ of the second public transport tool is introduced in the apparatus, and is used as a reference data to analyze whether there is a problem with reservation overdue when using the second public transport tool, thereby avoiding the problem of travel delays which may be caused because the reservation time threshold t₀ of the second public transport tool is not taken into account, and the second public transport tool could not be used due to reservation overdue when reaching the parking place of the second public transport tool. Therefore, the apparatus introduces the reservation time threshold t₀ of the second public transport tool as a reference data, thereby ensuring the results obtained from analyses more accurate and then reducing unnecessary delays of the travel time.

It should be noted that, in the above embodiment, when tᵢ₁+tᵢ₄₀≤t₀ or tᵢ₁+t_{i′}≤tᵢ₂, it is needed to obtain the third travel time tᵢ₃ required for traveling by the second public transport tool from the parking place of the second public transport tool closest to the starting end of the i-th congested road to the underground railway station. In order to simplify the analyzing process, the above apparatus may further include: a fourth determining circuit 6 and an instruction generation circuit 7.

The fourth determining circuit 6 is configured to, when tᵢ₁+t_{i′} ≤t₀, determine whether t₀ is less than or equal to tᵢ₂.

The instruction generation circuit 7 is configured to generate an obtaining trigger instruction when t₀≤tᵢ₂ or tᵢ₁+t_{i′} >tᵢ₂. The obtaining trigger instruction is configured to trigger to obtain the third travel time tᵢ₃ required for traveling by the second public transport tool from the parking place of the second public transport tool closest to the starting end of the i-th congested road to the underground railway station. The instruction generation circuit 7 is configured to generate a determining trigger instruction when t₀>tᵢ₂. The determining trigger instruction is configured to trigger to determine whether tᵢ₁+t_{i′} is greater than tᵢ₂.

Referring to FIG. 1 and FIG. 4, under what situations the apparatus obtains the third travel time tᵢ₃ will be described hereinafter in details.

When tᵢ₁+t_{i′}≤t₀, the fourth determining circuit 6 determines whether t₀ is less than or equal to tᵢ₂.

When t₀≤tᵢ₂, the instruction generation circuit generates an obtaining trigger instruction. The obtaining trigger instruction is configured to trigger to obtain the third travel time tᵢ₃ required for traveling by the second public transport tool from the parking place of the second public transport tool closest to the starting end of the i-th congested road to the underground railway station.

When t₀>tᵢ₂, the instruction generation circuit 7 is configured to generate a determining trigger instruction. The determining trigger instruction is configured to trigger to determine whether tᵢ₁+t_{i′} is greater than tᵢ₂.

As can be seen from the above description about the process of obtaining the third travel time tᵢ₃ in a variety of situations, the fourth determining circuit 6 determines whether t₀ is less than or equal to tᵢ₂ when tᵢ₁+t_{i′}≤t₀, a process of comparing tᵢ₁+t_{i′} with the tᵢ₂ can be omitted when t₀>tᵢ₂, thereby directly starting the process of obtaining the third travel time tᵢ₃ and then simplifying steps.

In addition, a quantity of all congested roads in the guidance route between the initial position and the underground railway station may be an integer greater than or equal to 1.

When a quantity n of congested roads in the guidance route is equal to 1, the i-th starting position is the initial position. At this point, the third traffic optimization information includes traveling by the first public transport tool from the initial position to the underground railway station.

When a quantity n of congested roads in the guidance route is greater than or equal to 2, when i=1, the i-th starting position is the initial position; and when i≥2, the i-th starting position is the starting end of the i-th congested road.

Further, as shown in FIG. 1 and FIG. 4, the apparatus further includes: an information outputting circuit 11 and an obtaining control circuit 8.

The information outputting circuit is configured to, when the first traffic optimization information is generated when i=1, output a first traffic optimization scheme for congested roads. The first traffic optimization scheme for congested roads includes traveling by the second public transport tool from the initial position to the underground railway station.

The information outputting circuit is further configured to, when the second traffic optimization information is generated when 1≤i≤n, output a second traffic optimization scheme for congested roads. The second traffic optimization scheme for congested roads includes: traveling by the first public transport tool from the initial position to the starting end of the i-th congested road, walking from the starting end of the i-th congested road to the parking place of the second public transport tool closest to the starting end of the i-th congested road, and traveling by the second public transport tool from the parking place of the second public transport tool closest to the starting end of the i-th congested road to the underground railway station.

The information outputting circuit is further configured to, when the third traffic optimization information is generated when i=n, output a third traffic optimization scheme for congested roads. The third traffic optimization scheme for congested roads includes traveling by the first public transport tool from the initial position to the underground railway station.

The obtaining control circuit 8 is configured to, when the third traffic optimization information is generated when 1≤i<n, control the obtaining circuit 1 to obtain passing time information for an (i+1)-th congested road.

It should be noted that, the first public transport tool cannot pass through the congested roads. The public transport tool is generally a taxi or a bus. Since the bus cannot be called at any time, the bus can only reach fixed bus stations at regular intervals, and thus has more restrictions on time and position. Therefore, the second public transport tool may be a taxi that can be called by a taxi client such as a Didi taxi client. At this point, when i=1, the first travel time tᵢ₁ includes a walking time tᵢ₁₁ required for walking from the i-th starting position to a parking place of the first public transport tool closest to the i-th starting position, a waiting time tᵢ₁₂ required for waiting for the first public transport tool at the parking place of the first public transport tool closest to the i-th starting position, and a driving time tᵢ₁₃ required for travelling by the first public transport tool from the parking place of the first public transport tool closest to the i-th starting position to the starting end of the i-th congested road. The second travel time tᵢ₂ includes a walking time tᵢ₂₁ required for walking from the i-th starting position to the parking place of the second public transport tool closest to the i-th starting position, and a driving time tᵢ₂₂ required for travelling by the second public transport tool from the parking place of the second public transport tool closest to the i-th starting position to the underground railway station. When i=1, the i-th starting position refers to the initial position. When i≥2, since the i-th starting position refers to the starting end of the i-th congested road, tᵢ₁=0, tᵢ₂=t_{i′}+tᵢ₃.

As shown in FIG. 6, one embodiment of the present disclosure provides a terminal device for optimizing traffic scheme for passing through congested roads. The terminal device includes a processor 100, a memory 200 and a transceiver 300. The processor 100, the memory 200 and the transceiver 300 are communicated with each other through a bus 400.

The memory 200 stores a plurality of instructions executed by the processor 100 to implement steps of the above method. The transceiver 300 supports communication between the processor 100 and the electronic map client as well as the second public transport tool client.

The processor 100 executes the plurality of instructions to implement steps of the above method. The processor 100 typically controls overall operations of the apparatus. Optionally, the processor 100 may be CPU, ASIC, FPGA or CPLD.

The memory 200 is configured to store various types of data to support the operation of the processor 100. The memory 200 can be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

A bus architecture (represented by the bus 400) may include a number of buses and bridges connected to each other, so as to connect various circuits for one or more processors and one or more memories. In addition, as is known in the art, the bus architecture may be used to connect any other circuits, such as a circuit for a peripheral device, a circuit for a voltage stabilizer and a power management circuit.

Through the description of the preferred embodiments, it can be clearly understood by those of skill in the art that the present disclosure can be realized by virtue of software plus necessary hardware platforms, and certainly it can also be realized totally by virtue of hardware. Based on this understanding, the technical solution of the present disclosure contributing to the prior art may be entirely or partly embodied in the software product form. The computer software product is stored in a storage medium, such as a ROM/RAM, a floppy disk, or an optical disk, and includes several instructions adapted to enable a computer device (such as a mobile phone, a personal computer, a server, an air conditioner or a network device) to execute the method according to each embodiment or certain parts of the embodiments of the present disclosure.

The above are merely the preferred embodiments of the present disclosure and shall not be used to limit the scope of the present disclosure. It should be noted that, a person skilled in the art may make improvements and modifications without departing from the principle of the present disclosure, and these improvements and modifications shall also fall within the scope of the present disclosure.

What is claimed is:

1. A method for optimizing traffic scheme for passing through congested roads, comprising:
step S100: obtaining passing time information for an i-th congested road, wherein the passing time information for the i-th congested road includes: a first travel time tᵢ₁ required for traveling by a first public transport tool from an i-th starting position to a starting end of the i-th congested road, a walking time t_{i′} required for walking from the starting end of the i-th congested road to a parking place of a second public transport tool closest to the starting end of the i-th congested road, a second travel time tᵢ₂ required for traveling by the second public transport tool from the i-th starting position to an underground railway station, where 1≤i≤n, and n represents a quantity of all congested roads in a guidance route between an initial position and the underground railway station;
step S300: determining whether tᵢ₁+t_{i′} is greater than tᵢ₂;
when tᵢ₁+t_{i′} >tᵢ₂, generating first traffic optimization information that includes traveling by the second public transport tool from the i-th starting position to the underground railway station; otherwise, performing step S400;
step S400: obtaining a third travel time tᵢ₃ required for traveling by the second public transport tool from the parking place of the second public transport tool closest to the starting end of the i-th congested road to the underground railway station; determining whether tᵢ₁+t_{i′}+tᵢ₃ is greater than tᵢ₂; when tᵢ₁+t_{i′}+tᵢ₃>tᵢ₂, generating the first traffic optimization information; otherwise, generating second traffic optimization information that includes traveling by the first public transport tool from the i-th starting position to the starting end of the i-th congested road, walking from the starting end of the i-th congested road to the parking place of the second public transport tool closest to the starting end of the i-th congested road, and traveling by the second public transport tool from the parking place of the second public transport tool closest to the starting end of the i-th congested road to the underground railway station.

2. The method of claim 1, wherein the second public transport tool has a reservation time threshold t₀, before the step S100 and the step S300, the method further includes:
step S200: determining whether tᵢ₁+t_{i′} is greater than t₀;
when tᵢ₁+t_{i′} >t₀, generating third traffic optimization information that includes traveling by the first public transport tool from the i-th starting position to a starting end of an (i+1)-th congested road; when tᵢ₁+t_{i′}≤t₀, performing the step S400.

3. The method of claim 2, wherein when tᵢ₁+t_{i′}≤t₀, before performing the step S400, the method further includes:
determining whether t₀ is less than or equal to tᵢ₂;
when t₀≤tᵢ₂, performing the step S400; otherwise, performing the step S300.

4. The method of claim 2, wherein n=1, the i-th starting position is the initial position; and the third traffic optimization information includes traveling by the first public transport tool from the initial position to the underground railway station.

5. The method of claim 2, wherein n≥2, when i=1, the i-th starting position is the initial position; when i≥2, the i-th starting position is the starting end of the i-th congested road.

6. The method of claim 5, wherein when tᵢ₁+t_{i′} >t₀, the step S200 further includes: when 1≤i<n, performing step S500; and when i=n, performing step S600;
the step S500 includes: when 1≤i<n, returning back to the step S100 to obtain passing time information for a next congested road;
the step S600 includes: outputting a third traffic optimization scheme for congested roads, where the third traffic optimization scheme for congested roads includes traveling by the first public transport tool from the initial position to the underground railway station;
when tᵢ₁+t_{i′} >tᵢ₂ and i=1, the step S300 further includes performing step S700;
when tᵢ₁+t_{i′}+tᵢ₃>tᵢ₂ and i=1, the step S400 further includes performing the step S700;
the step S700 includes: outputting a first traffic optimization scheme for congested roads, where the first traffic optimization scheme for congested roads includes traveling by the second public transport tool from the initial position to the underground railway station;
when tᵢ₁+t_{i′}+tᵢ₃≤tᵢ₂, the step S400 further includes performing step S800;
the step S800 includes: outputting a second traffic optimization scheme for congested roads, where the second traffic optimization scheme for congested roads includes: traveling by the first public transport tool from the initial position to the starting end of the i-th congested road, walking from the starting end of the i-th congested road to the parking place of the second public transport tool closest to the starting end of the i-th congested road, and traveling by the second public transport tool from the parking place of the second public transport tool closest to the starting end of the i-th congested road to the underground railway station.

7. The method of claim 1, wherein the obtaining passing time information for an i-th congested road includes:
step S101: sending travel information to an electronic map client, thereby enabling the electronic map client to analyze the travel information and then obtain the quantity n of all congested roads in the guidance route between the initial position and the underground railway station, the first travel time tᵢ₁ required for traveling by the first public transport tool from the i-th starting position to the starting end of the i-th congested road, the second travel time tᵢ₂ required for traveling by the second public transport tool from the i-th starting position to the underground railway station, and a position of the starting end of the i-th congested road;
step S102: obtaining the quantity n of all congested roads in the guidance route between the initial position and the underground railway station, the first travel time tᵢ₁ required for traveling by the first public transport tool from the i-th starting position to the starting end of the i-th congested road, the second travel time tᵢ₂ required for traveling by the second public transport tool from the i-th starting position to the underground railway station, and the position of the starting end of the i-th congested road;
step S103: obtaining a position of the parking place of the second public transport tool closest to the starting end of the i-th congested road from a second public transport tool client, according to the position of the starting end of the i-th congested road;
step S104: sending the position of the parking place of the second public transport tool closest to the starting end of the i-th congested road to the electronic map client, thereby enabling the electronic map client to analyze the position of the parking place of the second public transport tool closest to the starting end of the i-th congested road and then obtain the walking time t_{i′} required for walking from the starting end of the i-th congested road to the parking place of the second public transport tool closest to the starting end of the i-th congested road; and
step S105: obtaining the walking time t_{i′} required for walking from the starting end of the i-th congested road to the parking place of the second public transport tool closest to the starting end of the i-th congested road.

8. The method of claim 1, wherein when i=1, the first travel time tᵢ₁ includes a walking time tᵢₗₗ required for walking from the i-th starting position to a parking place of the first public transport tool closest to the i-th starting position, a waiting time tᵢ₁₂ required for waiting for the first public transport tool at the parking place of the first public transport tool closest to the i-th starting position, and a driving time tᵢ₁₃ required for travelling by the first public transport tool from the parking place of the first public transport tool closest to the i-th starting position to the starting end of the i-th congested road;
the second travel time tᵢ₂ includes a walking time tᵢ₂₁ required for walking from the i-th starting position to the parking place of the second public transport tool closest to the i-th starting position, and a driving time tᵢ₂₂ required for travelling by the second public transport tool from the parking place of the second public transport tool closest to the i-th starting position to the underground railway station;
when i≥2, tᵢ₁=0, tᵢ₂=t_{i′}+tᵢ₃.

9. An apparatus for optimizing traffic scheme for passing through congested roads, comprising:
an obtaining circuit configured to obtain passing time information for an i-th congested road, wherein the passing time information for the i-th congested road includes: a first travel time tᵢ₁ required for traveling by a first public transport tool from an i-th starting position to a starting end of the i-th congested road, a walking time t_{i′} required for walking from the starting end of the i-th congested road to a parking place of a second public transport tool closest to the starting end of the i-th congested road, a second travel time tᵢ₂ required for traveling by the second public transport tool from the i-th starting position to an underground railway station, where 1≤i≤n, and n represents a quantity of all congested roads in a guidance route between an initial position and the underground railway station;
a first determining circuit configured to determine whether tᵢ₁+t_{i′} is greater than tᵢ₂;
an information generation circuit configured to, when tᵢ₁+t_{i′} >tᵢ₂, generate first traffic optimization information that includes traveling by the second public transport tool from the i-th starting position to the underground railway station;
a second determining circuit configured to determine whether tᵢ₁+t_{i′}+tᵢ₃ is greater than tᵢ₂;
wherein the obtaining circuit is further configured to, when tᵢ₁+t_{i′}≤tᵢ₂, obtain a third travel time tᵢ₃ required for traveling by the second public transport tool from the parking place of the second public transport tool closest to the starting end of the i-th congested road to the underground railway station;
wherein the information generation circuit is further configured to, when tᵢ₁+t_{i′}+tᵢ₃>tᵢ₂, generate the first traffic optimization information; when tᵢ₁+t_{i′}+tᵢ₃≤tᵢ₂, generate second traffic optimization information that includes traveling by the first public transport tool from the i-th starting position to the starting end of the i-th congested road, walking from the starting end of the i-th congested road to the parking place of the second public transport tool closest to the starting end of the i-th congested road, and traveling by the second public transport tool from the parking place of the second public transport tool closest to the starting end of the i-th congested road to the underground railway station.

10. The apparatus of claim 9, wherein the second public transport tool has a reservation time threshold t₀, the apparatus further includes: a third determining circuit configured to determine whether tᵢ₁+t_{i′} is greater than t₀;
wherein the information generation circuit is further configured to, when tᵢ₁+t_{i′} >t₀, generating third traffic optimization information that includes traveling by the first public transport tool from the i-th starting position to a starting end of an (i+1)-th congested road; and
the obtaining circuit is further configured to, when tᵢ₁+t_{i′}≤t₀, obtain the third travel time tᵢ₃ required for traveling by the second public transport tool from the parking place of the second public transport tool closest to the starting end of the i-th congested road to the underground railway station.

11. The apparatus of claim 10, further comprising:
a fourth determining circuit configured to, when tᵢ₁+t_{i′}≤t₀, determine whether t₀ is less than or equal to tᵢ₂;
an instruction generation circuit configured to, generate an obtaining trigger instruction when t₀≤tᵢ₂, and generate a determining trigger instruction when t₀>tᵢ₂;
wherein the obtaining trigger instruction is configured to trigger to obtain the third travel time tᵢ₃ required for traveling by the second public transport tool from the parking place of the second public transport tool closest to the starting end of the i-th congested road to the underground railway station; and the determining trigger instruction is configured to trigger to determine whether tᵢ₁+t_{i′} is greater than tᵢ₂.

12. The apparatus of claim 10, wherein n=1, the i-th starting position is the initial position; and the third traffic optimization information includes traveling by the first public transport tool from the initial position to the underground railway station.

13. The apparatus of claim 10, wherein n≥2, when i=1, the i-th starting position is the initial position; when i≥2, the i-th starting position is the starting end of the i-th congested road.

14. The apparatus of claim 13, further comprising: an information outputting circuit and an obtaining control circuit;
wherein the information outputting circuit is configured to,
when the first traffic optimization information is generated when i=1, output a first traffic optimization scheme for congested roads, where the first traffic optimization scheme for congested roads includes traveling by the second public transport tool from the initial position to the underground railway station;
when the second traffic optimization information is generated when 1≤i≤n, output a second traffic optimization scheme for congested roads, where the second traffic optimization scheme for congested roads includes: traveling by the first public transport tool from the initial position to the starting end of the i-th congested road, walking from the starting end of the i-th congested road to the parking place of the second public transport tool closest to the starting end of the i-th congested road, and traveling by the second public transport tool from the parking place of the second public transport tool closest to the starting end of the i-th congested road to the underground railway station;
when the third traffic optimization information is generated when i=n, output a third traffic optimization scheme for congested roads, where the third traffic optimization scheme for congested roads includes traveling by the first public transport tool from the initial position to the underground railway station;
wherein the obtaining control circuit is configured to, when the third traffic optimization information is generated when 1≤i<n, control the obtaining circuit to obtain passing time information for an (i+1)-th congested road.

15. The apparatus of claim 9, further comprising: an information inputting circuit;
wherein the information inputting circuit is configured to send travel information to an electronic map client, thereby enabling the electronic map client to analyze the travel information and then obtain the quantity n of all congested roads in the guidance route between the initial position and the underground railway station, the first travel time tᵢ₁ required for traveling by the first public transport tool from the i-th starting position to the starting end of the i-th congested road, the second travel time tᵢ₂ required for traveling by the second public transport tool from the i-th starting position to the underground railway station, and a position of the starting end of the i-th congested road;
the obtaining circuit is further configured to obtain the quantity n of all congested roads in the guidance route between the initial position and the underground railway station, the first travel time tᵢ₁ required for traveling by the first public transport tool from the i-th starting position to the starting end of the i-th congested road, the second travel time tᵢ₂ required for traveling by the second public transport tool from the i-th starting position to the underground railway station, and the position of the starting end of the i-th congested road;
the obtaining circuit is further configured to obtain a position of the parking place of the second public transport tool closest to the starting end of the i-th congested road from a second public transport tool client, according to the position of the starting end of the i-th congested road;
the information inputting circuit is further configured to send the position of the parking place of the second public transport tool closest to the starting end of the i-th congested road to the electronic map client, thereby enabling the electronic map client to analyze the position of the parking place of the second public transport tool closest to the starting end of the i-th congested road and then obtain the walking time t_{i′} required for walking from the starting end of the i-th congested road to the parking place of the second public transport tool closest to the starting end of the i-th congested road; and
the obtaining circuit is further configured to obtain the walking time t_{i′} required for walking from the starting end of the i-th congested road to the parking place of the second public transport tool closest to the starting end of the i-th congested road.

16. The apparatus of claim 9, wherein when i=1, the first travel time tᵢ₁ includes a walking time tᵢₗₗ required for walking from the i-th starting position to a parking place of the first public transport tool closest to the i-th starting position, a waiting time tᵢ₁₂ required for waiting for the first public transport tool at the parking place of the first public transport tool closest to the i-th starting position, and a driving time tᵢ₁₃ required for travelling by the first public transport tool from the parking place of the first public transport tool closest to the i-th starting position to the starting end of the i-th congested road;
the second travel time tᵢ₂ includes a walking time tᵢ₂₁ required for walking from the i-th starting position to the parking place of the second public transport tool closest to the i-th starting position, and a driving time tᵢ₂₂ required for travelling by the second public transport tool from the parking place of the second public transport tool closest to the i-th starting position to the underground railway station;
when i≥2, tᵢ₁=0, tᵢ₂=t_{i′}+tᵢ₃.
